(19) United States
(12) Patent Application Publication
(10) Pub. No.: US 2022/0253848 A1
(43) Pub. Date: Aug. 11, 2022

(54) ELECTRONIC PAYMENT REVERSION

(71) Applicant: Wells Fargo Bank, N.A., San Francisco, CA (US)

(72) Inventors: Suneela Tatineni, Hyderabad (IN); Naresh Golakoti, Hyderabad (IN); N. Rahul Jain, Hyderabad (IN)

(21) Appl. No.: 17/096,531

(22) Filed: Nov. 12, 2020

(51) Int. Cl. G06Q 20/40; G06Q 20/10; G06Q 40/02

(52) U.S. Cl. CPC G06Q 20/407; G06Q 40/02; G06Q 20/108

(57) ABSTRACT

An electronic payment transaction is subject to reversion. A payer can initiate payment by way of a first transaction that transfers an amount of money from a payer account to a payee account in near real time. Subsequently, the payer can issue a request to reverse the transaction due to error or fraud, for example. In response to the request, the first transaction can be reversed, for instance by a second transaction that transfers the amount of money from the payee account to the payer account. In accordance with one aspect, reversal can be permitted within a predetermined elapsed time from the first transaction. Further, checks performed prior to reversal can be employed to mitigate risk of fraud.

### BACKGROUND

Rapid technological development has fueled an age of instant gratification. With smart phone ubiquity and ever-increasing network speed, individuals expect experiences without delay. The expectation is that everything should not be more than a few clicks away, including sending and receiving payments. Real-time payment systems satisfy this expectation or demand. Real-time payment systems offer seemingly instant and always available electronic fund transfer by way of one of many computing device channels including smart phones, tablets, and the web. In such a system, account to account transfers and notification are provided in near real time.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to electronic payment reversion. A payer can transfer an amount of money electronically to a payee in real time or near real time. More specifically, a first transaction can be specified to debit an account of the payer and credit an account of a payee the amount of money. Subsequently, a reversion request can be submitted to reverse, or rollback, the previous transfer, for instance in response to identification of an error. In response to the reversion request, the account of the payee can be debited, and the account of the payer credited. In accordance with one aspect, the reversion request can be validated to determine whether or not the request is timely with respect to a predetermined period of time after the transaction. Further, a request can be validated to reduce the risk of fraud. For instance, the request can be scrutinized to ensure that the transaction was not previously reversed. Furthermore, details of the first transaction can be compared with details of the second transaction that reverses the first to protect against fraud.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates an overview of an example implementation.

FIG. 2 is a block diagram of a sample reversion system.

FIGS. 3A-B are example screenshots of electronic payment processing.

FIG. 4 is an example flow chart diagram of a method of payment processing.

FIG. 5 is an example flow chart diagram of a method of payment reversion.

FIG. 6 is an example flow chart diagram of a method of payment processing that supports reversion.

FIG. 7 is a block diagram of an example scenario.

FIG. 8 is a flow diagram of an example scenario.

FIG. 9 is a schematic block diagram illustrating a suitable operating environment for aspects of the subject disclosure.

### DETAILED DESCRIPTION

Payment transactions are subject to error, including human error. For real-time payment systems, transaction speed can increase the risk of error. For instance, money might be transferred to the wrong recipient by mistake. Moreover, there is no prompt recourse for an erroneous transaction. Rather, the person to whom money was erroneously transferred needs to be located and coaxed into issuing a refund. Individuals can often feel helpless after money is lost due to their mistake, because there is no effective immediate remedy to recover the money.

Details provided herein generally pertain to electronic payment reversion of erroneous transactions. A mechanism is provided to enable lost money to be recovered promptly by reversing the transaction, for instance in the case of an erroneous transaction. After a payer initiates a transaction to submit payment to a payee, the transaction can be reverted within a predetermined time period at the direction of the payer. Upon receipt of a request to revert, reverse, or rollback a transaction, a determination can be made as to whether or not the request occurred within a predetermined time period from the transaction sought to be rolled back. If the request occurs within the predetermined time period, the process can continue to validate the request to protect against fraud. For example, account numbers and amounts requested can be compared against a transaction designated for reversion. Further, a check can be made to ensure the transaction was not previously reversed. Once verification completes successfully, money associated with the transaction can be reverted, for example by crediting an account of the initial payer and debiting an account of the initial payee or otherwise voiding the transaction. On the payee side, money received from the payer can be placed on hold for a predetermined time in one embodiment to ensure funds are available to return to the payer should the payer seek to reverse the transaction. Alternatively, money could be debited from the account balance.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

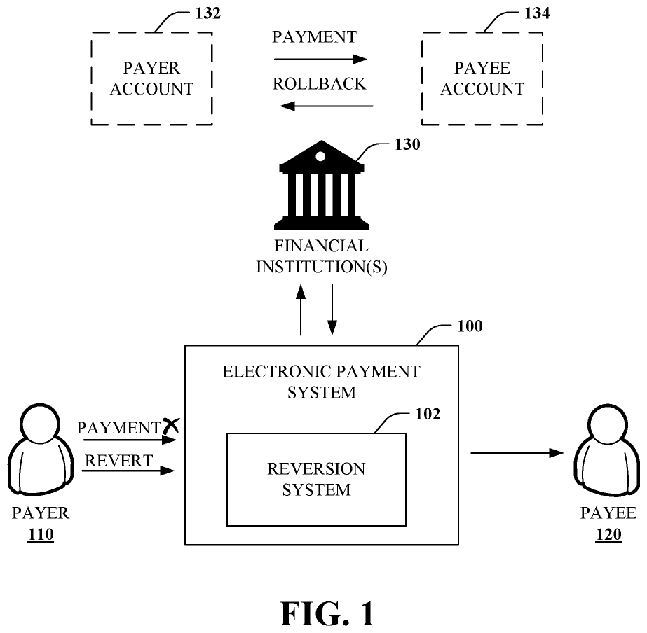

Referring initially to FIG. 1, a high-level overview of an example implementation is illustrated and described hereinafter. As depicted, the implementation includes an electronic payment system 100. The electronic payment system 100 provides a means to transfer money. For example, funds can be transferred online from person-to-person or person-to-business. The electronic payment system 100 can be embodied as a mobile banking application or mobile wallet, among other embodiments. As depicted, the electronic payment system 100 can be engaged by a payer 110, by way of a computing device, to transfer money to payee 120. The electronic payment system 100 interacts with financial institution 130, such as a bank, to make a payment that transfers money from payer account 132 to payee account 134. In accordance with one embodiment, the payment or transfer of funds can occur in near real time. In other words, a payer can designate a payee to receive money and the money can be provided to the payee in substantially real time. This is a highly expeditious process. However, this process is subject to errors, including human error.

Given the ease and quickness of payment, it is possible that the payer 110 mistakenly sends payment to a payee 120. For example, multiple payees could have the same or similar name, and the payer 110 accidently selects an unintended payee 120 for payment. Alternatively, a payer 110 could inadvertently submit payment for an incorrect amount (e.g., $110 vs. $11). Electronic payment system 100 can complete a payment transaction in or near real time, for example by debiting the payer account 132 and crediting the payee account 134. This is problematic for addressing mistakes in payment transactions, as the payment amount is almost instantly available for use by the payee 120.

Without more, there is no immediate recourse to a mistake by the payer 110. Rather, in one instance, the payer 110 can seek to contact and solicit a refund from the payee 120. Alternatively, a lengthy process can be undertaken to involving the payment processing system and administrators to potentially assist. However, such involved processes and associated delay are unacceptable.

The electronic payment system 100 includes reversion system 102. The reversion system 102 provides a mechanism to enable erroneous transactions to be reverted, or, in other words, reversed or rolled back. Further, the reversion system 106 can be configured to revert an erroneous transaction in near real time. In one embodiment, the electronic payment system 100 operates with respect to a predetermined time period in which transaction reversion can be performed. In this manner, transaction finality can be achieved at some definite time after submission.

The payer 110 can issue a request to revert or rollback a prior submitted transaction. If the request is received within a stipulated or predetermined time, communication can subsequently be performed with the one or more financial institutions 130 to perform such an action. In response, the payer account 132 can be credited and the payee account 134 debited in near real time. This can be performed within one financial institution or multiple financial institutions depending on where the payer account 132 and the payee account 134 reside. In addition to reversing the effect by debiting the payee account 134 and crediting the payer account 132, other functionality can be employed to remove evidence of an erroneous transaction or otherwise make note of the erroneous transaction.

The reversion system 102 can also coordinate activities across financial institutions. In one instance, employment of the reversion system 102 can involve an agreement to perform certain activities to facilitate reversion including permitting a subsequent transaction within a predetermined time period to reverse a prior transaction or voiding the prior transaction within the predetermined time period. Further, the reversion system 102 is flexible enough to allow various options. For example, money received from a transaction can be placed on hold for a predetermined time period, wherein the predetermined time period can be the same or different than the predetermined time period associated with permitting or denying reversion. In this manner, a financial institution can avoid a risk of a lack of funds to support a subsequent reversion, if it happens. Further, upon a request for reversion the amount of money held associated with a transaction can simply be cancelled and removed.

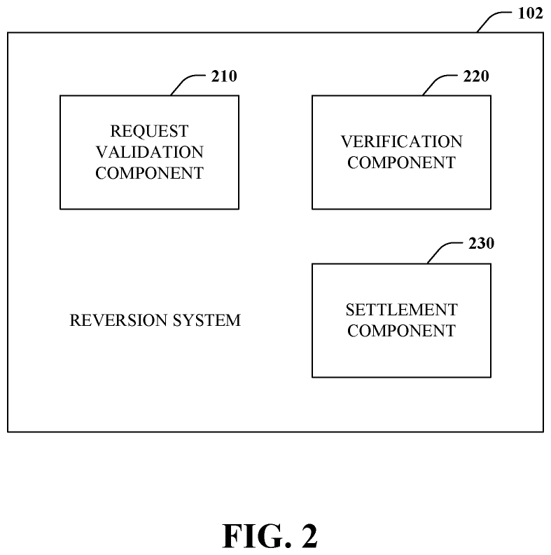

FIG. 2 depicts the reversion system 102 in further sample detail. The reversion system 102 includes a request validation component 210, verification component 220, and settlement component 230. The request validation component 210 can check whether or not a request to revert a transaction is timely, the verification component 220 can perform a check to determine the accuracy and appropriateness of a request to revert a transaction to mitigate fraud, for instance, and the settlement component 230 can ensure funds for erroneous transactions are returned to payers. In one embodiment, the request validation component 210, the verification component 220, and the settlement component 230 are computer executable components that when executed cause a computer to implement functionality of the reversion system 102 as described herein.

The request validation component 210 is configured to validate a request to revert or rollback a transaction based on when the request was received compared to a predetermined time period. In accordance with one embodiment, a stipulated or predetermined time period can be established for when reversion is permitted. If a reversion is sought for a transaction within the predetermined time period, such as five or ten minutes, such reversion can be permitted. Otherwise, reversion can be denied. The predetermined time period seeks to balance transaction finality with error correction.

Furthermore, the predetermined time period is configurable and optionally variable based on context. In one instance the predetermined time period can be based at least in part on the amount transferred. For example, a five-dollar transfer may result in a shorter time period than a one-thousand-dollar transfer. Similarly, the time period can be specific to a particular payer or payee. In another instance probability of a correct transaction can be employed to influence the time period. As an example, if it is determined that the payer has a history of erroneous transactions, the time period may be extended beyond a default for the payer or alternatively reduced for a payer that does not make many, if any, errors historically. As another example, consider a situation where it can be determined that two individuals are in close proximity at a restaurant at lunch time and payment is transmitted from one of the individuals to the other individual. In light of the context, it is likely that the transaction is not erroneous and as such the time period may be less than a default time period.

The request validation component 210 can compute a time period between when a transaction was submitted and when a request to revert the transaction was received. Subsequently, the request validation component 210 can compare the computed time period to a predetermined time period to check if reversion is allowed. If the time period is less than the predetermined time period, the reversion is allowed for the transaction. Thus, the transaction can be deemed valid or validated. If the time period is equal to or greater than the predetermined time period, reversion is not allowed, and thus the transaction can be deemed invalid or invalidated with respect to reversion. Stated differently, elapsed time from when a transaction was submitted and when a reversion request is received can be taken into account in determining whether or not the reversion request is valid or invalid.

The verification component 220 is configured to verify if reversion is justified. In one instance, the verification component 220 can act to filter out fraudulent reversion. In one embodiment, the verification component 220 can seek to determine whether a transaction was previously reverted and filter out multiple reversions on a single transaction. A flag can be associated with a transaction that is set after a transaction is reverted. If reversion is subsequently requested, the flag can be checked. If the flag is set, the reversion is not justified, and if the flag is not set the reversion is justified. In another embodiment, the verification component 220 can compare aspects of a reversion request against the corresponding transaction. For instance, a comparison can be made of an amount requested for reversion against the amount of the transaction to ensure they match. Likewise, the verification component 220 can ensure that payer and payee in the reversion request match those of the transaction. The verification component 220 can perform numerous other checks. In one embodiment, functionality of the request validation component 210 can be combined with functionality of the verification component 220 in an aggregate validation/verification component or the like.

The settlement component 230 is configured to move funds between parties associated with completing transaction reversion or rollback. The original payer of the transaction can be credited, and the original payee can be debited the amount of the transaction. In other words, a transaction is reversed such that the payer becomes the payee and the payee becomes the payer. When both the payer and the payee maintain accounts at the same financial institution, the settlement component 230 instructs the financial institute to reverse the transaction, which effectively results in an immediate debit of a payee account and credit of the payer account. When the payer and payee maintain accounts at different financial institutions, the settlement component 230 can communicate with respective financial institutions of the payee and the payer and request a transaction be reverted or rolled back. This can result in a debit to a payee account and a credit to the payer account to reverse an original debit to the payer account and credit to the payee account. Although discussion has focused on employing a second counter transaction to reverse the effect of a prior transaction, it also contemplated that the transaction can simply be removed as if it never happened for both the payer and payee. However, it may be desirable to maintain all transaction details. In this case, block chain or other ledger technology can be employed to track transactions. For example, block chain can be employed to save transaction in an immutable form necessitating debits and credits of the accounts of the customer and payee.

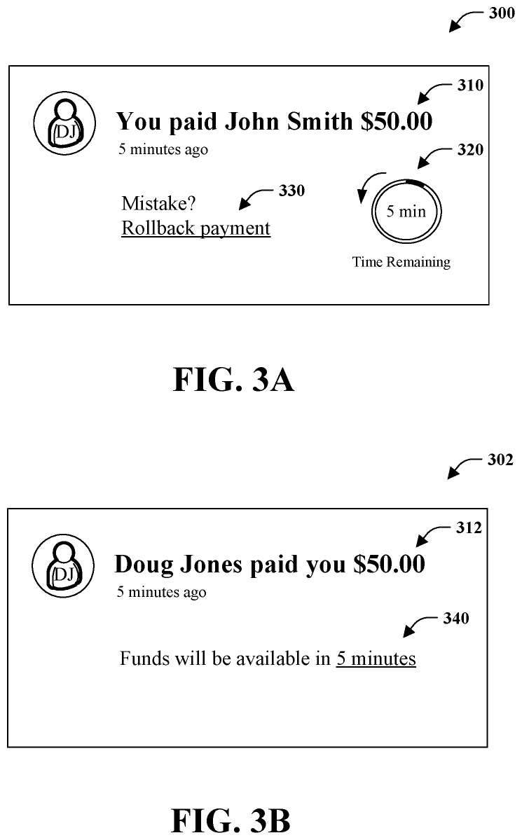

Turning attention to FIGS. 3A-B, example screenshots are provided to facilitate clarity and understanding with respect to aspects of payment reversion. FIG. 3A depicts a sample presentation 300 for a payer, and FIG. 3B illustrates an example presentation 302 for a payee associated with an electronic person-to-person payment.

The sample presentation 300 can be presented to a payer named Doug Jones. Doug Jones submits an electronic payment of $50 to John Smith, the payee. The sample presentation indicates the recipient, John Smith, the amount, $50.00, as well as the time since the payment was submitted, five minutes ago, at numeral 310. At numeral 320, a graphic representation of the time remaining for transaction reversion or rollback is illustrated. Here, there is a backward facing arrow on a circle to indicate rollback. Further, there is a shaded portion of the circle indicating five minutes remains as well as text indicating five minutes of time remains. The graphic representation can be continuously updated in near real time to indicate time remaining. At reference numeral 330, a mechanism is provided to trigger rollback for the transaction if a mistake occurred. Although not limited thereto, in this case the mechanism is a selectable link named “Rollback payment.”

The example presentation 302 can be presented to a payee named John Smith. At reference numeral 312, the example presentation indicates that Doug Jones paid him $50.00 five minutes ago. Further, at 340, it is noted that funds, namely the $50.00 transferred to John Smith, will be available for use in five minutes. In this scenario, a predetermined time period is associated with availability of received funds. This time period can correspond to the predetermined time period associated with availability of rollback or a different time period. In this scenario, funds are transferred in near real time as usual. However, fund availability is limited to enable funds to be returned if a mistake was made. In essence, a financial institute can reduce risk associated with a lack of availability of funds with respect to reverting a transaction by placing a hold on the funds for a predetermined time period. The time period indicated at 340 can be updated in near real time to reflect when the hold will be released and the funds available.

There are at least two scenarios associated with aspects of this disclosure. A first scenario can concern transactions that take place between two bank accounts belonging to the same bank. A second scenario concerns transactions that take place between two bank accounts belonging to two different banks. What follows is a further description of the scenarios and examples to facilitate clarity and understanding.

In the first scenario, a customer of a bank can initiate a transaction to pay an amount to a payee. However, the customer makes a mistake while performing the transaction and erroneously transfers the amount to the wrong payee. The transaction took place between two bank accounts belonging to the same bank. The customer notifies his bank about the error and seeks to revert the transaction. The customer's bank verifies this request of the customer. After successful verification, the customer's bank reverts the amount to the customer. For every transaction, there is a debit record and a credit record. In this scenario in which both the sender and receiver accounts are in the same bank, the bank can simply create another set of debit and credit records to offset the erroneous transaction.

Consider the following example. Person A wants to send money to person B. Both person A and person B have accounts at the same bank. While initiating the transaction, person A mistakenly transfers money to person C, who happens to have the same name as person B and an account at the same bank. Person A identifies he made an erroneous transaction. Subsequently, person A requests that the bank revert the erroneous transaction. Thereafter, the bank verifies the genuineness of the mistake and whether the request was made in a stipulated limited time (e.g., one day). If the bank is satisfied with the request, it will revert the transaction. In a case when person C immediately uses the money received from the erroneous transaction, the bank may credit person A and may deduct the amount from the account of person C when the account has requisite funds or debit another account at the bank that has the required funds.

With respect to the second scenario, a customer can initiate a transaction to transfer an amount to a payee. The customer erroneously transferred the amount to the wrong payee. Moreover, the customer and the wrong payee have bank accounts at different banks. The customer can notify his bank of the erroneous transaction. The customer's bank verifies the request and contacts the payee bank regarding the error. The customer's bank next reverts the transaction after successful verification.

For instance, assume person A wants to send money to person B. Person A has an account at bank Z, whereas person B has an account at bank X. Person A mistakenly sends money to person C and person C′s bank, bank X. This scenario involves interplay between two banks, namely the customer's bank and the receiver's bank. In accordance with one embodiment, the banks can have an agreement between them with regard to reverting payments near real time based on certain predefined rules or limits. For instance, a limited time period of four hours (or before settlement at the end of each day) from the time money was transferred can define when reversion is permissible and when it is not.

In accordance with one embodiment, payment reversion may be offered as a service to subscribe to and offered as a premium service by a financial institution. Further, there may be a reversal charge for each transaction reverted. For example, a reversal charge could be a set amount or percentage of a transaction amount. Additionally, the reversal charge can, in one embodiment, be deducted from the money being credited to a payer that initiated the reversal. Consequently, rather than receiving $50 back, the payer can receive $45 with a $5 service fee deducted.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. By way of example, and not limitation, the reversion system 102 need not be a system within the electronic payment system 100 but rather can be separate and communicatively coupled thereto. Further yet, one or more components and/or sub-components may be combined into a single component to provide aggregate functionality. For instance, the validation and verification components could be combined into a single component. Further, communication between systems, components and/or sub-components can be accomplished in accordance with either a push and/or pull control model. The components may also interact with one or more other components not specifically described herein for sake of brevity, but known by those of skill in the art.

Various portions of the disclosed systems above and methods below can include or employ artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, among others, can automate certain mechanisms or processes performed thereby to make portions of the systems and methods more adaptive as well as efficient and intelligent. By way of example, and not limitation, the reversion system 102 can employ such mechanisms with respect to optimal selection of predetermined time periods associated with availability of rollback as well as funds, and identification of potential fraud or mistake. Further, these mechanism can be employed to determine or predict context information that can influence rollback including likelihood that a transaction is fraudulent versus genuine.

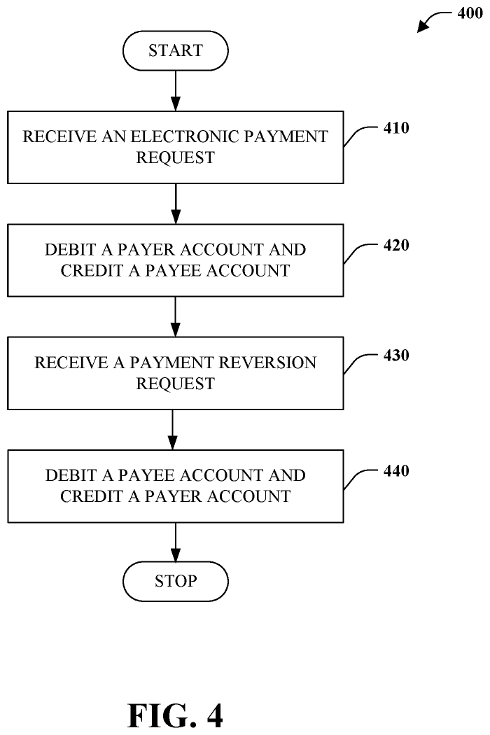

In view of the exemplary systems described above, methods that may be implemented in accordance with the disclosed subject matter will be better appreciated with reference to flow chart diagrams of FIGS. 4-6. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

FIG. 4 illustrates a method 400 of payment processing. The method 400 can be implemented and executed by the electronic payment system 100 and reversion system 102. At reference numeral 410, an electronic payment request is received. The request can be for person-to-person, person-to-business, business-to-person, or business-to-business payment. As described above, the payment request can indicate the payee and an amount, among other things.

At numeral 420, a payer account is debited an amount and a payee account is credited the amount. The accounts can be bank or other financial institution accounts, and the accounts can be maintained by the same financial institution or different financial institutions.

At 430, a payment reversion request is received. For instance, a payment transaction may have mistakenly identified a receiver or payee, or an amount may have been entered incorrectly. In response, a request can be submitted to reverse, or revert, the transaction, which is received at 430. As described herein, timing of triggering a reversion request can be based upon variable factors, e.g., time, amount, location, etc.

At 440, the request is processed by debiting the payee account for the amount that was originally credited and crediting the payer account the amount. Here, a return notification of the success ion the reversion can be sent to the payer and/or the payee via most any mean including but not limited to inter-APP notification, SMS (short message service), email, mail, or the like.

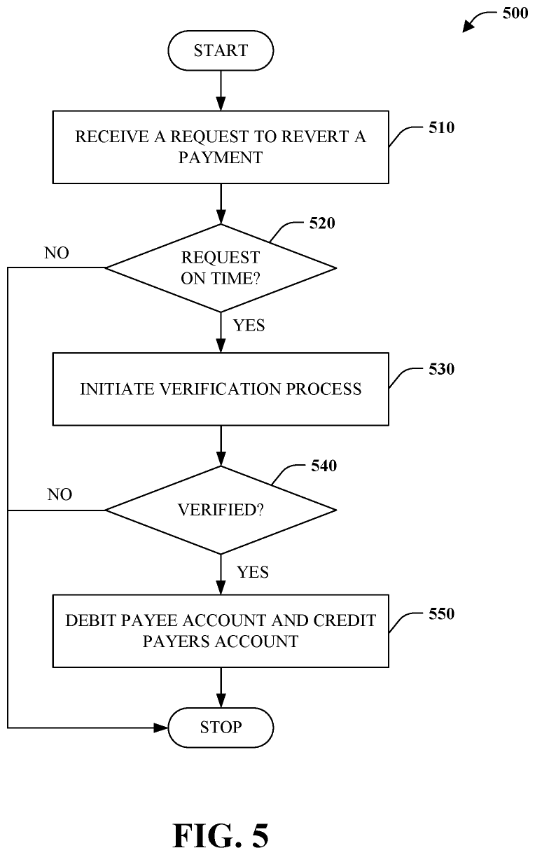

FIG. 5 is a flow chart diagram of a method 500 of payment reversion. The method 500 can be executed by the reversion system 102 and various components thereof. At reference numeral 510, a request is received to revert a payment transaction that was previously submitted.

At 520, a determination is made as to whether or not the request is on time. Stated differently, request validation is determined. In accordance with one embodiment, reversion or rollback can be available for a limited time after the original transaction. The time can be predetermined and configurable as well as variable. For example, the time can be up to ten minutes or one day or change based on transaction details and/or contextual factors. In one instance, the time seeks to balance availability for reversion and transaction finality. To determine if the request is on time, a comparison can be made between a predetermined time period and the time between the request to revert and submitting the transaction. If the request to revert is received within a predetermined time period, the request is on time. If the request to revert is receive later than the predetermine time period, the request is not timely. If the request is not on time (“NO”), the method 500 can simply terminate. If the request is on time (“YES”), the method 500 continues at 530.

At 530, a verification process is initiated. The verification process is intended to verify the genuineness of the request to revert. In other words, the verification process seeks to identify and prevent fraudulent reversion. Verification can involve one or more checks. For example, one check can pertain to whether or not a transaction subject to a request to revert was previously reverted. In one instance, a flag can be associated with a transaction that when set indicates the transaction was reverted and an unset flag denotes a transaction that has not been reverted. The check can thus involve analyzing the flag state. Other checks can be associated with consistency of a request and a target transaction. For example, a check can determine whether or not there is a match between a requested amount and the transaction amount. Alternatively, a determination can involve comparing identities of the payer and payee in the transaction and in the request.

At 540, a determination is made as to whether or not the request has been verified. In other words, a determination is made as to whether or not the request passed one or more verification checks. If all verification checks are passed, then the request is deemed verified. Otherwise, the request can be said to be unverified. If the request is not verified (“NO”), the method terminates. If the request is verified (“YES”), the method 500 continues at 550.

At 550, a payee account is debited, and a payer account is credited. The amount credited and debited can be the same as long as there is no fee associated with reversion that is deducted. If there is a fee, the fee can be deducted from the amount to be credited. Further, the payment transaction is reversed such that the original payee now becomes the payer and the original payer becomes the payee. In accordance with one embodiment, debiting the payee account and crediting the payer account can occur within the context of a single financial institution. Here, the financial institution can perform both actions. In another embodiment, the payer account and the payee account can be maintained by separate financial institutions. In this case, actions can be communicated to the separate financial institutions to be executed. For example, a payer account can be credited by the payer financial institution and a request can be communicated to the payee financial institution to debit the payee account. In accordance with one embodiment, communication between financial institutions can be facilitated by a component or process of a reversion system. In this scenario, a separate channel can be established for communications regarding reversions.

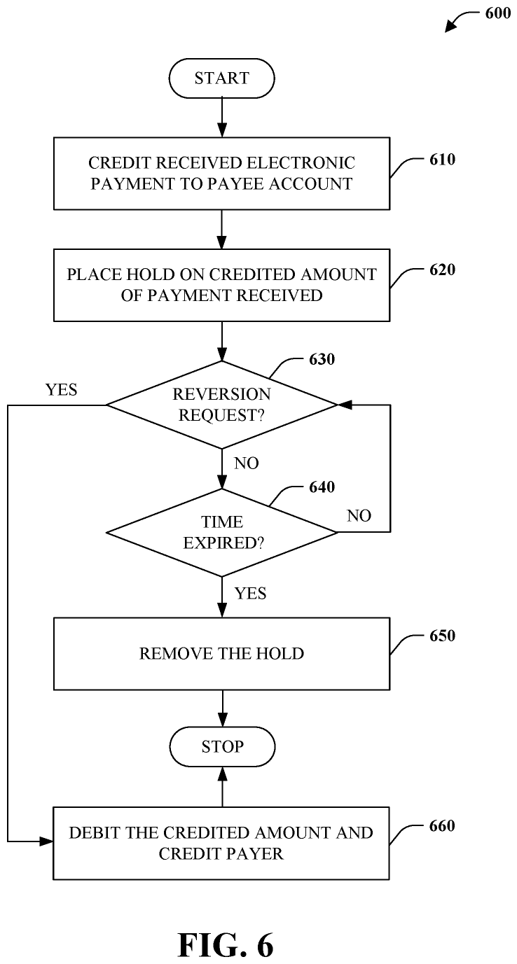

FIG. 6 is a flow chart diagram of a method 600 of payment processing that supports potential reversion. Functionality of the method 600 can be implemented within the reversion system 102 and corresponding components. At reference numeral 610, a received electronic payment is credited to a payee account. For example, funds can be transferred from a payer account to the payee account in near real time. At 620, a hold is placed on the credited amount of the payment received. The hold prevents the credited amount from being used immediately, and thus preserves the amount for potential return to a payer in case the transaction is determined to be erroneous and reversion is requested.

At numeral 630, a determination is made as to whether or not a reversion request or the like has been received with respect to the payment transaction. A reversion request seeks to reverse, undo, or rollback a payment transaction to return the parties to their original financial positions just prior to the payment transaction.

If at numeral 630 no reversion request has been received (“NO”), the method 600 continues on to 640. At 640, a determination is made as to whether or not a predetermined time has expired. The predetermined time can be a set time to maintain the hold. The predetermined time can be the same as the predetermined time associated with allowance of reversion or a different time. If, at 640, the time has not expired (“NO”), the method 600 returns to 630. If the time has expired (“YES”), the method 600 continues to 650, where the hold is removed, and the method terminates. At this point the payment transaction funds are available for use.

If at numeral 630, a reversion request has been received (“YES”), the method proceeds to 660. At 660, the credited payment amount can be debited from the payee account and credited to a payer account. Stated differently, the amount on hold can be returned to the payer. The amount can be returned to the payer by way of a new transaction that reverses the effect of a transaction to be reversed. However, other mechanisms could be employed such as voiding the transaction. In this manner a record is maintained regarding a transaction, but voiding the transaction negates its effect.

The method 600 utilizes a hold to reduce risk that funds will not be available should the transaction be reversed. Thus, the hold is a risk mitigation mechanism. The hold is not required and may not be required in certain circumstances. Rather, the amount can be debited from an available balance of the payee in the account. In some cases, there can be a delay in debiting the payee account due to a lack of funds. In one instance, such a scenario would not affect return of funds to the payer. Instead, the financial institution associated with the account would provide the available funds and later recover the funds from the payee.

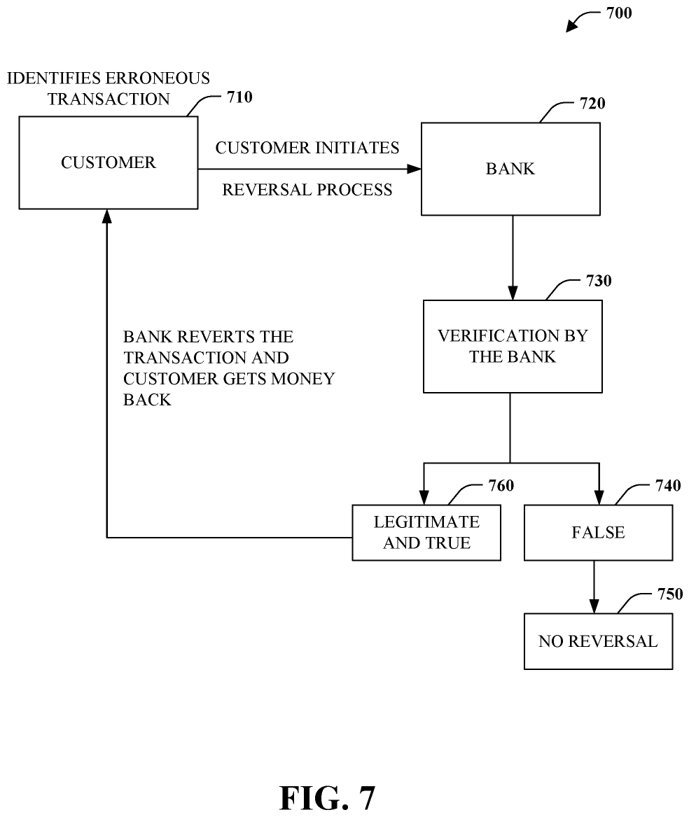

FIG. 7 depicts an example scenario 700 to highlight aspects of the subject disclosure. At 710, a customer identifies an erroneous transaction and initiates a reversal process. For example, the customer initiates a transaction to pay an amount to a payees but makes a mistake while performing the transaction and erroneously transfers the amount to the wrong payee. The reversal process can be initiated by a customer by notifying the customer's bank about the error and desire to revert the transaction. At 720, the bank receives a request to reverse the process. In this scenario, it is assumed that the payer and payee have different accounts at the same bank. At 730, verification is performed by the bank. The verification can correspond to the genuineness of the mistake and whether the request is made within a predetermined period of time, such as one day. If the verification is false at 740, no reversal will be performed at 750. If the verification deems the request legitimate and true at 760, the bank reverts the transaction and the customer reacquires her money.

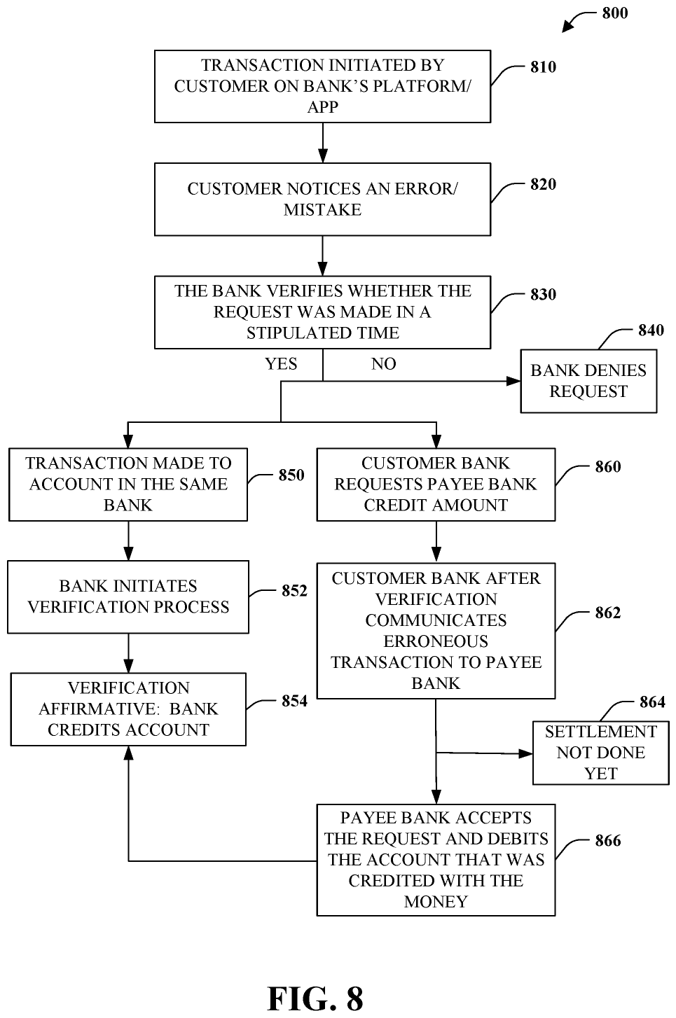

FIG. 8 depicts an example flow diagram 800 highlighting aspects of the subject disclosure. At numeral 810, a customer of a bank initiates a transaction by way of the bank's platform or application. At 820, the customer notices an error or mistake. For example, the customer may have sent transaction to the wrong payee. At 830, the bank verifies whether or not the request was made within a stipulated time. If the request was not made in the stipulated time (e.g., NO), the bank denies the request at 840. Alternatively, if the bank verifies the request was made within the stipulated time, the method continues alone one of two paths based on whether the customer and the payee are customers of the same bank or different banks. At 850, a determination is made that the transaction was made to an account in the same bank. At 852, the bank initiates a verification process to determine the genuineness of the mistake. At 854, if the bank is satisfied that the mistake was genuine based on factors surrounding the mistake, for example, verification is affirmed, and the bank credits the account for the amount of the transaction. By contrast, if the customer and the payee accounts are at different banks, the customer bank can request the payee bank credit the amount to the customer bank account. After verification of the genuineness of the error or mistake, the customer bank communicates the erroneous transaction to the payee bank. If settlement is not been completed at this time, it can be noted that settlement has not been done yet, at 864. Alternatively, the payee bank accepts the request and debits the account that was credited with the money, at 866. Subsequently, the customer bank can credit the amount to the customer after verification at 854.

The subject disclosure pertains to reverting electronic payment transactions. Electronic payments are processed in near real time. Likewise, transaction reversion can be performed in near real time. Another option in dealing with electronic payment transactions and potential error is to introduce delay in the process to allow errors to be corrected prior to submitting an electronic payment. For instance, a payer can initiate a transfer of funds to a payee but instead of instantly sending, delay can be introduced to allow the transfer to be rescinded. Although the transfer may appear to have been completed, the transfer may in fact be held for a predetermined time. However, payers and payees expect transfers to be completed in near real time, so introduction of delay may be undesirable, especially a lengthy delay such as hours or a day to allow error correction. Nevertheless, such a delay feature can be utilized in conjunction with real time features. For instance, after a transfer is initiated a short delay of a few seconds may be introduced to allow review of transaction details and an ability to cancel the transfer before it is completed. After this delay, the mechanisms described herein can be utilized to later reverse the transaction if needed. Stated differently, delay may seem antithetical to real time processing, as introduction of a delay can reduce the speed of response. However, a small delay, for example of a few seconds, associated with initiating a transaction can be utilized to potentially prevent submission of an erroneous transaction. Once the transaction is initiated, aspects of real time payment and reversion can be employed. As such, delay and real time reversion can be complimentary techniques.

Aspects of the subject disclosure concern a technical problem associated with payment reversion in conjunction with electronic payment processing. The technical solution involves transferring funds in near real time and establishing a predetermined time in which a transaction can be reverted. Further, transferred funds can optionally be placed on hold to reduce risk should the transaction later be reverted to due to an error, for example. The reversion can also be performed in near real time. Multiple financial institutions can cooperate electronically to ensure near real time reversion when accounts reside at different institutions.

The subject disclosure provides for various products and processes that are configured to perform payment processing including optional reversion and various functionality related thereto. What follows are one or more example systems and methods.

A system comprises a processor coupled to a memory that includes instructions that when executed by the processor cause the processor to initiate a first transaction that transfers an amount of money from a payer account to a payee account in near real time, and initiate a second transaction after the first transaction, wherein the second transaction transfers the amount of money from the payee account to the payer account in near real time in response to a request by the payer to reverse the first transaction. In one instance, the first transaction is a person-to-person payment. However, the first transaction could also be person-to-business, business-to-business, or business-to-person. The instructions can further cause the processor to prevent initiation of the second transaction after a predetermined time from initiation of the first transaction. Further, the instructions can cause the processor to record a first time associated with the first transaction, determine a second time associated with receipt of the request, compute a difference between the first time and the second time, and permit initiation of the second transaction when the difference is less than a predetermined maximum time. The predetermined maximum time can be configurable based on the payee or other transaction details such as the amount. The instructions can further cause the processor to verify the second transaction prior to initiation, for example by determining a number of reversals performed with respect to the first transaction and confirming the number is less than one. Further, verifying the second transaction can also comprise determining that the amount of the first transaction matches the amount of the second transaction.

A method comprises executing, on a processor, instructions that cause the processor to perform operations comprising: initiating a first transaction that transfers an amount money from a payer account to a payee account in near real time; recording a first time associated with initiating the first transaction, identifying a second time associated with receipt of a request rollback the first transaction, computing a time frame as a difference between the first time and the second time, and initiating a second transaction that rolls back the first transaction when the time frame is less than a predetermined maximum, wherein the second transaction transfers the amount of money from the payee account to the payer account in near real time. The operations further comprise verifying the second transaction prior to initiating the second transaction. Verifying the second transaction can comprise determining that a previous transaction was not performed rolling back the first transaction, determining a match between the amount of the first transaction and the amount of the second transaction or confirming the payer account and the payee account of the first transaction matches accounts specified by the second transaction. The operations can further comprise configuring the predetermined maximum, including based on the identity of one of the payer or payee or the amount of money. Initiating the second transaction comprises invoking a rollback process of a second financial institution, wherein the payee account is maintained by the second financial institution and the payer account is maintained by first financial institution distinct from the second financial institution.

A method comprises executing, on a processor, instructions that cause the processor to perform operations comprising initiating a transaction that transfers an amount of money from a payer account to a payee account in near real time recording a first time of initiating the transaction, determining a second time associated with receipt of a rollback request, computing a time interval between the first time and the second time, and triggering a rollback process when the time interval is less than a predetermined maximum time, wherein the rollback process reverses the transaction. The operations further comprise preventing the triggering of the rollback process when the rollback process was previously executed for the transaction. The method can further comprise operations that introduce a delay prior to initiating the transaction and after a request to initiate the transaction is received and preventing the initiation the transaction in response to a cancelation signal received prior to expiration of the delay.

Reverting, reversing, and rolling back a transaction is described herein. These terms are intended to capture the act of returning the parties, namely payer and payee, to their financial positions just prior to the payment transaction, essentially negating the transaction. This can be accomplished in various ways. For example, a second transaction can be initiated that reverses the effect of an original transaction by crediting a payer account and debiting a payee account. Alternatively, a transaction can be voided or canceled. Typically, transactions can be voided only prior to settlement, or in other words before money is transferred between parties. However, since electronic payment systems operate in real time or near real time, the concept of voiding or canceling transactions is extended to apply after settlement. For example, this can be accomplished in accordance with an agreement between financial institutions, when more than one financial institution is involved.

This disclosure uses the terms “real time” and “near real time” herein. Generally, real time can refer to the actual time at which a process or event occurs without delay. With automated systems, however, there is always some degree of delay associated with data processing and communication, among other things. In this context, real time refers to a response time in which the response is so close to instantly (e.g., sub-second) that a human does not notice any delay. However, this is a high bar to meet, especially in light of inherent physical latency as well as variations in communication and processing speed. As such, near real time is utilized to refer to time that is slightly longer than real time in which delay introduced by automated data processing and communication is considered.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “'X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

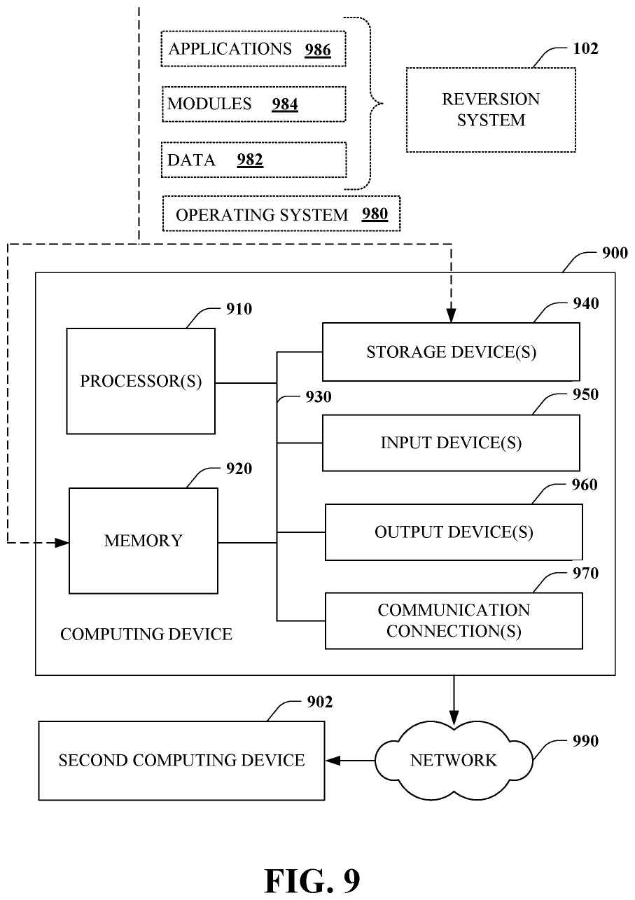

To provide a context for the disclosed subject matter, FIG. 9 as well as the following discussion are intended to provide a brief, general description of a suitable environment in which various aspects of the disclosed subject matter can be implemented. The suitable environment, however, is solely an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smart phone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 9, illustrated is an example computing device 900 (e.g., desktop, laptop, tablet, watch, server, hand-held, programmable consumer or industrial electronics, set-top box, game system, compute node . . . ). The computing device 900 includes one or more processor(s) 910, memory 920, system bus 930, storage device(s) 940, input device(s) 950, output device(s) 960, and communications connection(s) 970. The system bus 930 communicatively couples at least the above system constituents. However, the computing device 900, in its simplest form, can include one or more processors 910 coupled to memory 920, wherein the one or more processors 910 execute various computer executable actions, instructions, and or components stored in the memory 920.

The processor(s) 910 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 910 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 910 can be a graphics processor unit (GPU) that performs calculations with respect to digital image processing and computer graphics.

The computing device 900 can include or otherwise interact with a variety of computer-readable media to facilitate control of the computing device to implement one or more aspects of the disclosed subject matter. The computer-readable media can be any available media that is accessible to the computing device 900 and includes volatile and nonvolatile media, and removable and non-removable media. Computer-readable media can comprise two distinct and mutually exclusive types, namely storage media and communication media.

Storage media includes volatile and nonvolatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that store, as opposed to transmit or communicate, the desired information accessible by the computing device 900. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media.

The memory 920 and storage device(s) 940 are examples of computer-readable storage media. Depending on the configuration and type of computing device, the memory 920 may be volatile (e.g., random access memory (RAM)), non-volatile (e.g., read only memory (ROM), flash memory . . . ) or some combination of the two. By way of example, the basic input/output system (BIOS), including basic routines to transfer information between elements within the computing device 900, such as during start-up, can be stored in nonvolatile memory, while volatile memory can act as external cache memory to facilitate processing by the processor(s) 910, among other things.

The storage device(s) 940 include removable/non-removable, volatile/non-volatile storage media for storage of vast amounts of data relative to the memory 920. For example, storage device(s) 940 include, but are not limited to, one or more devices such as a magnetic or optical disk drive, floppy disk drive, flash memory, solid-state drive, or memory stick.

Memory 920 and storage device(s) 940 can include, or have stored therein, operating system 980, one or more applications 986, one or more program modules 984, and data 982. The operating system 980 acts to control and allocate resources of the computing device 900. Applications 986 include one or both of system and application software and can exploit management of resources by the operating system 980 through program modules 984 and data 982 stored in the memory 920 and/or storage device(s) 940 to perform one or more actions. Accordingly, applications 986 can turn a general-purpose computer 900 into a specialized machine in accordance with the logic provided thereby.

All or portions of the disclosed subject matter can be implemented using standard programming and/or engineering techniques to produce software, firmware, hardware, or any combination thereof to control the computing device 900 to realize the disclosed functionality. By way of example and not limitation, all or portions of the payment processing system 100 can be, or form part of, the application 986, and include one or more modules 984 and data 982 stored in memory and/or storage device(s) 940 whose functionality can be realized when executed by one or more processor(s) 910.

In accordance with one particular embodiment, the processor(s) 910 can correspond to a system on a chip (SOC) or like architecture including, or in other words integrating, both hardware and software on a single integrated circuit substrate. Here, the processor(s) 910 can include one or more processors as well as memory at least similar to the processor(s) 910 and memory 920, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the reversion system 102 and/or functionality associated therewith can be embedded within hardware in an SOC architecture.

The input device(s) 950 and output device(s) 960 can be communicatively coupled to the computing device 900. By way of example, the input device(s) 950 can include a pointing device (e.g., mouse, trackball, stylus, pen, touch pad . . . ), keyboard, joystick, microphone, voice user interface system, camera, motion sensor, and a global positioning satellite (GPS) receiver and transmitter, among other things. The output device(s) 960, by way of example, can correspond to a display device (e.g., liquid crystal display (LCD), light emitting diode (LED), plasma, organic light-emitting diode display (OLED) . . . ), speakers, voice user interface system,, printer, and vibration motor, among other things. The input device(s) 950 and output device(s) 960 can be connected to the computing device 900 by way of wired connection (e.g., bus), wireless connection (e.g., Wi-Fi, Bluetooth . . . ), or a combination thereof

The computing device 900 can also include communication connection(s) 970 to enable communication with at least a second computing device 902 by means of a network 990. The communication connection(s) 970 can include wired or wireless communication mechanisms to support network communication. The network 990 can correspond to a local area network (LAN) or a wide area network (WAN) such as the Internet. The second computing device 902 can be another processor-based device with which the computing device 900 can interact. For example, the computing device 900 can form part of a platform that exposes the reversion system 102 as a service. The second computing device 902 can be utilized by a customer to initiate payments and utilize the reversion system to rollback erroneous transactions.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

1. A system, comprising:
a processor coupled to a memory that includes instructions that when executed by the processor cause the processor to:
cause transfer, in a first transaction of an amount of money from a payer account to a payee account in near real time;
predetermine a maximum time for reversion based on the amount of money;
identify a first time associated with the first transaction;
identify a second time associated with receipt of a request to reverse the first transaction;
determine a difference between the first time and the second time;
determine whether the difference is less than the predetermined maximum time; and
in an instance in which the difference is less than the predetermined maximum time:
cause transfer, in a second transaction, of the amount of money from the payee account to the payer account in near real time.

2. The system of claim 1, wherein the first transaction is a person-to-person payment.

3. (canceled)

4. (canceled)

5. The system of claim 1, wherein the predetermined maximum time is configurable.

6. The system of claim 5, wherein the predetermined maximum time is configurable based on the payee account.

7. The system of claim 1, wherein the instructions further cause the processor to verify the second transaction prior to causing transfer of the amount of money in the second transaction.

8. The system of claim 7, wherein verifying the second transaction comprises:
determining a number of reversals performed with respect to the first transaction; and
confirming the number is less than one.

9. The system of claim 7, wherein verifying the second transaction comprises determining that the amount of money in the first transaction matches an amount of money indicated in the request to reverse the first transaction.

10. A method, comprising:
executing, on a processor, instructions that cause the processor to perform operations comprising:
causing transfer, in a first transaction, of an amount of money from a payer account to a payee account in near real time;
predetermining a maximum time for reversion based on the amount of money
identifying a first time associated with the first transaction;
identifying a second time associated with receipt of a request to reverse the first transaction;
determining a difference between the first time and the second time:
determining whether the difference is less than the predetermined maximum time; and
in an instance in which the difference is less than the predetermined maximum time:
causing transfer, in a second transaction, of the amount of money from the payee account to the payer account in near real time.

11. The method of claim 10, wherein the operations further comprise verifying the second transaction prior to causing transfer of the amount of money in the second transaction.

12. The method of claim 11, wherein verifying the second transaction comprises determining that a previous transaction reversing the first transaction was not performed.

13. The method of claim 10, wherein verifying the second transaction comprises determining a match between the amount of money in the first transaction and an amount of money indicated in the request to reverse the first transaction.

14. The method of claim 10, wherein verifying the second transaction comprises confirming the payer account and the payee account of the first transaction match accounts indicated in the request to reverse the first transaction.

15. The method of claim 10, the operations further comprise configuring the predetermined maximum time.

16. The method of claim 15, the operations further comprise configuring the predetermined maximum tune based on the amount of money.

17. The method of claim 10, wherein causing transfer of the amount of money in the second transaction comprises invoking a rollback process of a second financial institution, wherein the payee account is maintained by the second financial institution and the payer account is maintained by a first financial institution distinct from the second financial institution.

18. A non-transitory computer-readable medium comprising software instructions that, when executed, perform operations comprising:
causing transfer, in a first transaction, of an amount of money from a payer account to a payee account in near real time;
predetermining a maximum time for reversion based on the amount of money
identifying a first time associated with the first transaction;
identifying a second time associated with receipt of a request to reverse the first transaction;
determining a difference between the first time and the second time;
determining whether the difference is less than the predetermined maximum time; and
in an instance in which the difference is less than the predetermined maximum time:
causing transfer, in a second transaction, of the amount of money from the payee account to the payer account in near real time.

19. The non-transitory computer-readable medium of claim 18, wherein causing transfer of the amount of money in the second transaction is performed in response to determining that a previous transaction reversing the first transaction was not performed.

20. The non-transitory computer-readable medium of claim 18, the operations further comprising:
introducing a delay prior to causing transfer of the amount of money in the first transaction and after receipt of a request to cause transfer of the amount of money in the first transaction,
wherein causing transfer of the amount of money in the second transaction is performed. in response to not receiving a cancelation signal prior to expiration of the delay.
